(19) United States
(12) Patent Application Publication
(10) Pub. No.: US 2017/0076239 A1
(43) Pub. Date: Mar. 16, 2017

(54) INCIDENT MANAGEMENT ANALYSIS

(71) Applicant: Honeywell International Inc., Morristown, NJ (US)

(72) Inventors: Anantha Padmanabha Rahul U, Bangalore (IN); Jagmeet Puri, Bangalore (IN); Magesh Lingan, Bangalore (IN); Naveen Prabhu, Bangalore (IN); Ambuj Nema, Bangalore (IN); Balamurugan B, Bangalore (IN); Ramesh A, Bangalore (IN)

(21) Appl. No.: 14/855,898

(22) Filed: Sep. 16, 2015

(51) Int. Cl. G06Q 10/06; G06Q 50/26

(52) U.S. Cl. CPC G06Q 10/06398; G06Q 50/265

(57) ABSTRACT

Devices, methods, and systems for incident management analysis are described herein. One device includes a memory and a processor configured to execute executable instructions stored in the memory to receive information associated with management of a number of incidents at a site, wherein each respective incident is managed by an operator using a standard operating procedure associated with that incident, analyze the number of incidents using the received information, and provide the analysis of the number of incidents to a user.

### TECHNICAL FIELD

The present disclosure relates to devices, methods, and systems for incident management analysis.

### BACKGROUND

A security incident can refer to any type of event that could lead to loss of, and/or disruption to, an organization's operations, services, and/or functions. For instance, a security incident can be and/or include a fire, a bomb threat, a terrorist attack, or severe weather, among other examples. If not properly managed, a security incident could escalate into an emergency, crisis, and/or disaster.

Incident management can refer to the process of limiting the potential disruption and/or loss caused by an incident (e.g., a security incident), and returning the organization's operations, services, and/or functions to normal (e.g., returning to business as usual). An incident management system may include standard operating procedures that can be used to manage incidents. A standard operating procedure may include a number of steps for a user to follow, such as, for instance, a sequence of actions to take, during an incident, and different standard operating procedures may be used to manage different types of incidents.

An incident management system may store information about incidents and/or the standard operating procedures used to manage those incidents such as, for instance, the steps of the standard operating procedures that have been executed by an operator during incidents, comments entered by the operator while executing the steps, and/or the status of the incidents. However, previous incident management systems may not be able to provide any sort of analysis that could be used to improve the management of current (e.g., in-progress) and/or future incidents.

### BRIEF DESCRIPTION OF THE DRAWINGS

FIG. 1 illustrates an example of a system for incident management analysis in accordance with one or more embodiments of the present disclosure.

FIG. 2 illustrates an example of an incident analysis performed in accordance with one or more embodiments of the present disclosure.

FIG. 3 illustrates an example of a computing device for incident management analysis in accordance with one or more embodiments of the present disclosure.

### DETAILED DESCRIPTION

Devices, methods, and systems for incident management analysis are described herein. For example, one or more embodiments include a memory, and a processor configured to execute executable instructions stored in the memory to receive information associated with management of a number of incidents at a site, wherein each respective incident is managed by an operator using a standard operating procedure associated with that incident, analyze the number of incidents using the received information, and provide the analysis of the number of incidents to a user.

Incident management analysis in accordance with the present disclosure can be used to improve the management of current (e.g., in-progress) and/or future incidents. For example, incident management analysis in accordance with the present disclosure can be provided to a manager of a site, who can use the analysis to improve the management of current and/or future incidents at the site. For instance, the site manager can use the analysis to better understand, assess, and/or improve an operator's management of incidents at the site and/or the steps of the standard operating procedures used to manage incidents at the site.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of incidents” can refer to one or more facilities.

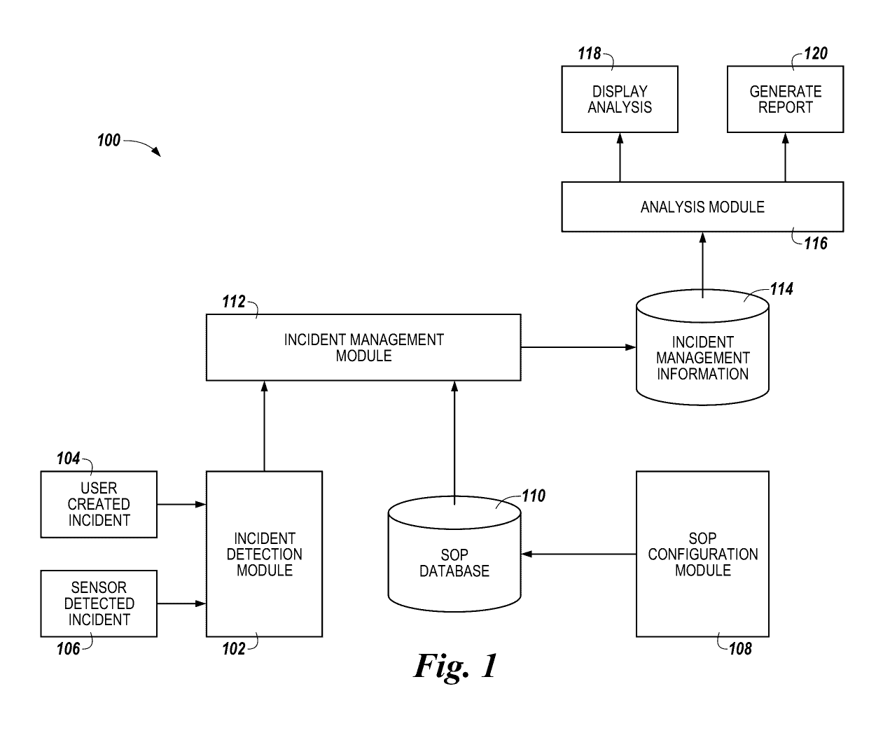

FIG. 1 illustrates an example of a system 100 for incident management analysis in accordance with one or more embodiments of the present disclosure. As shown in FIG. 1, system 100 can include an incident detection module 102. Incident detection module 102 can detect incidents that may occur at a site, such as sensor detected incidents 106 (e.g., incidents that are detected by sensor devices at the site) and/or user created incidents 104 (e.g., incidents input and/or initiated by an operator of system 100).

As used herein, an incident can include and/or refer to a security incident, which can be any type of event that could lead to loss of, and/or disruption to, an organization's operations, services, and/or functions. That is, detection module 102 can detect security incidents that may occur at the site, such as, for instance, a fire, bomb threat, terrorist attack, or severe weather. However, embodiments of the present disclosure are not limited to these examples.

As used herein, a site can refer to the location where an incident(s) is occurring. For instance, a site can be a single building or facility, a plurality (e.g., group) of buildings, an area (e.g., room(s), space(s), zone(s), etc.) within a building or facility, or a campus of an organization. However, embodiments of the present disclosure are not limited to these examples.

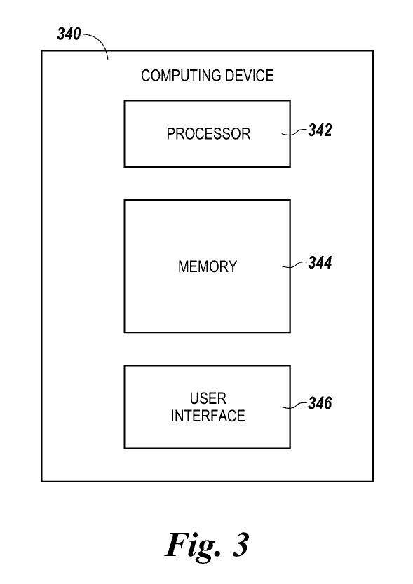

As used herein, a “module” can include computer readable instructions that can be executed by a processing resource (e.g., processor 342 further described in connection with FIG. 3) to perform a particular function. A module can also include hardware, firmware, and/or logic that can perform a particular function. As used herein, “logic” is an alternative or additional processing resource to execute the actions and/or functions, described herein, which includes hardware (e.g., various forms of transistor logic, application specific integrated circuits (ASICs)), as opposed to computer executable instructions (e.g., software, firmware) stored in memory and executable by a processing resource.

As shown in FIG. 1, system 100 can include a standard operating procedure (SOP) configuration module 108. SOP configuration module 108 can configure standard operating procedures that can be used to manage incidents that may occur at a site. For example, an operator of system 100 can use SOP configuration module 108 to configure the standard operating procedures. The standard operating procedures can be stored in SOP database 110 of system 100, as illustrated in FIG. 1.

A standard operating procedure (e.g., a standard operating procedure configured by SOP configuration module 108) can include a number of steps for a user (e.g., operator) to follow, such as, for instance, a sequence actions to take, during an incident in order to successfully manage the incident (e.g., to limit the potential disruption and/or loss caused by the incident and return the organization's operations, services, and/or functions to normal). The steps (e.g., sequence of actions) of the standard operating procedure may depend on the type of incident the standard operating procedure is being used to manage (e.g., the steps of a standard operating procedure for managing a fire may be different than the steps of a standard operating procedure for managing a bomb threat). That is, SOP configuration module 108 can configure different standard operating procedures to manage different types of incidents that may occur at the site. Further, the steps of the standard of the standard operating procedure may depend on the location of the incident (e.g., the location within a building) at the site.

As shown in FIG. 1, system 100 can include an incident management module 112. Incident management module 112 can manage incidents that may occur at the site (e.g., incidents detected by incident detection module 102). For example, an operator or operators of system 100 can use incident management module 112 to manage the incidents (e.g., attempt to limit the potential disruption and/or loss caused by the incidents and return the organization's operations, services, and/or functions to normal) using the standard operating procedures stored in SOP database 110. For instance, the operator(s) can use incident management module 112 to manage a number of incidents at the site, wherein each respective incident is managed by the operator(s) using the standard operating procedure stored in SOP database 110 that is associated with (e.g. used to manage) that type of incident.

As shown in FIG. 1, system 100 can include an incident management information database 114. Incident management information database 114 can store information associated with the management of the incidents that may occur at the site (e.g., incidents detected by incident detection module 102). For example, incident management information database 114 can store information associated with each respective operator's management of each respective incident using the standard operating procedures stored in SOP database 110. Incident management information database 114 can also store information associated with the steps (e.g., sequence of actions) of the standard operating procedures associated with (e.g., used to manage) each respective incident. The information stored in incident management information database 114 may be determined and/or recorded by incident management module 112 during the management of the incidents.

The information associated with the management of a particular incident (e.g., the information associated with a particular operator's management of a particular incident) that may be stored in SOP database 110 may include, for example, when the incident occurred, the start time and end time of the incident, and/or the duration of the incident. The start time of an incident can refer to the time the incident is detected by incident detection module 102, and the end time of an incident can refer to the time the incident is successfully resolved (e.g., the time when the final step of the standard operating procedure for managing that incident has been completed).

The information associated with the management of a particular incident may also include the type of the incident. The type of an incident can correspond to (e.g., be determined based on) the standard operating procedure used to manage the incident. Examples of different types of incidents can include fire, bomb threat, terrorist attack, severe weather, public disturbance, theft, medical emergency, security breach, asset damage, and evacuation, among others. However, embodiments of the present disclosure are not limited to these examples.

The information associated with the management of a particular incident may also include the priority level of the incident. Examples of different priority levels can include urgent, high, and low. However, embodiments of the present disclosure are not limited to these examples.

The information associated with the management of a particular incident may also include the current status of the incident. Examples of different statuses can include raised, open, and closed. A raised status can refer to any incident that that has been detected by incident detection module 102. An open status can refer to any incident that has been raised but not yet managed (e.g., responded to) by incident management module 112 and/or is in the process of being managed by incident management module 112. That is, an open status can refer to any raised incident that has not yet been successfully resolved by incident management module 112. A closed status can refer to any raised incident that has been successfully resolved by incident management module 112 (e.g., any raised incident for which the final step of the standard operating procedure for managing that incident has been completed). However, embodiments of the present disclosure are not limited to these examples.

The information associated with the management of a particular incident may also include the number of actions automatically performed (e.g., by incident management module 112 without input from the operator or in response to a command from the operator) during the process of managing the incident. The information associated with an operator's management of a particular incident may also include the number of actions performed by the operator (e.g., by incident management module 112 based on input from the operator and/or in response to a command from the operator) during the process of managing the incident.

The information associated with the steps of a standard operating procedure used to manage a particular incident that may be stored in SOP database 110 may include, for example, which steps of the standard operating procedure have been performed (e.g., executed) by incident management module 112 (e.g., by the operator), and which steps of the standard operating procedure have not been performed, during the process of managing the incident. The steps that have been performed may, for example, be checked off by the operator after they are performed. The information associated with the steps of a standard operating procedure used to manage a particular incident may also include the amount of time needed to perform each respective step of the standard operating procedure.

As shown in FIG. 1, system 100 can include an analysis module 116. Analysis module 116 can receive the incident management information (e.g., the information associated with each respective operator's management of each respective incident, and the information associated with the steps of the standard operating procedures used to manage each respective incident) from incident management information database 114, and analyze (e.g., perform and/or provide an analysis of) the incidents using the received information.

The analysis of the incidents can include, for example, an analysis of an operator's performance (e.g., efficiency) in managing the incidents. The analysis of the operator's performance can include a measurement of the operator's turnaround time in managing the incidents, such as, for instance, the total amount of time needed by the operator to successfully resolve all the incidents and/or the average amount of time needed by the operator to successfully resolve one of the incidents. As an additional example, the analysis of the operator's performance can include the total number of steps performed by the operator in managing (e.g., resolving) all the incidents, and/or the average number of steps performed by the operator in managing (e.g., resolving) one of the incidents. Further, the analysis of the operator's performance can include an input/output trend for the operator, such as, for instance, the amount of open incidents currently being and/or to be managed by the operator as compared to (e.g., versus) the amount of incidents that have been successfully resolved (e.g., closed) by the operator. Further, the analysis of the operator's performance can include a classification of the priority levels and/or types of the incidents being managed by the operator. Further, the analysis of the operator's performance can include a comparison of the operator's performance (e.g., the operator's turnaround time, number of steps performed, input/output trend, and/or priority level and/or type classifications) to the performance of other operators.

The analysis of the incidents can also include an incident response time measurement such as, for example, the total amount of time needed to respond to all the incidents and/or the average amount of time needed to respond to one of the incidents. The response time for an incident can refer to the amount of time that passes between when the incident is detected by incident detection module 102 and when incident management module 112 begins to perform the standard operating procedure (e.g., begins to execute the first step of the standard operating procedure) associated with the incident.

The analysis of the incidents can also include an analysis of the incidents for (e.g., occurring within) a particular time period, such as, for example, a weekly or monthly incident analysis. However, embodiments of the present disclosure are not limited to a particular time period.

The analysis of the incidents for a particular time period can include, for example, a status comparison of the incidents for that time period. For instance, the analysis can include the total amount of incidents that occurred (e.g., that were detected by incident detection module 102) during the time period, the amount of those incidents that occurred during the time period that were successfully resolved (e.g., by incident management module 112) during the time period, and the amount of those incidents that occurred during the time period that were not successfully resolved during the time period. That is, the status comparison can include a comparison of the amount of raised, open, and closed (e.g., closed versus open and raised versus closed) incidents during the time period. Further, the status comparison may be presented as a trend that includes a status comparison of the incidents (e.g., the amount of raised, open, and/or closed incidents) at different times during, and/or throughout, the time period.

The analysis of the incidents for a particular time period can also include a priority level comparison of the incidents for that time period. For example, the analysis can include a classification of the incidents for that time period into a number of different priority levels (e.g., urgent, high, and low), and the amount of those incidents classified into each respective priority level (e.g., the amount of urgent versus high versus low incidents during the time period). Further, the priority level comparison may be presented as a trend that includes a priority level comparison of the incidents (e.g., the amount of urgent, high, and/or low incidents) at different times during, and/or throughout, the time period.

The analysis of the incidents can also include an analysis of the incidents by type. The analysis of the incidents by type can include, for example, a classification of the incidents into a number of different types (e.g., fire, bomb threat, terrorist attack, severe weather, etc.), and an indication of which type of incident(s) has occurred most frequently. For instance, the analysis can include an indication of which type of incident(s) has been raised and/or escalated most frequently. Further, the analysis can include a status comparison for each type of incident (e.g., the amount of each type of incident that is raised, open, and/or closed).

The analysis of the incidents by type can also include an indication of which type of incident takes longest to successfully resolve (e.g., which type of incident consumes the most of the operator's time). The analysis of the incidents by type can also include an indication of which type of incident is managed and/or resolved using the most automated actions (e.g., the most actions automatically performed by incident management module 112 during the process of managing the incident). The analysis of the incidents by type can also include an indication of which type of incident has the longest turnaround time (e.g., which type of incident takes the longest to successfully resolve).

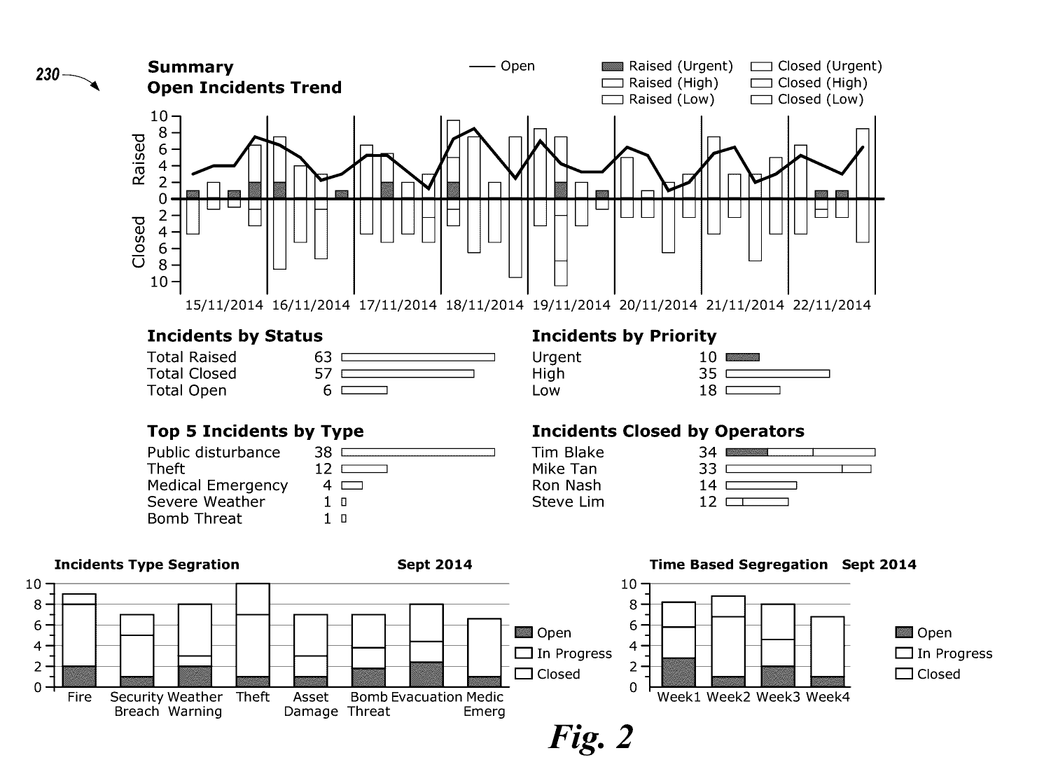

An example of an incident analysis performed by analysis module 116 that includes an analysis of an operator's performance, a time period analysis, and a type analysis will be further described herein (e.g., in connection with FIG. 2). However, embodiments of the present disclosure are not limited to the example incident analysis described in connection with FIG. 2.

Further, analysis module 116 can analyze (e.g., perform and/or provide an analysis of) the steps of the standard operating procedure associated with each respective incident using the incident management information (e.g., the information associated with the steps of the standard operating procedure used to manage each respective incident) received from incident management information database 114. The analysis of the steps of a standard operating procedure can include, for example, an indication of the step(s) of the standard operating procedure that are being performed least frequently and/or not at all during the management of its respective incident. For instance, the analysis can include an indication of the steps having automated actions (e.g., actions to be automatically performed by incident management module 112) that are being skipped, and/or an indication of the steps having actions to be performed by the operator that are being skipped by the operator.

The analysis of the steps of a standard operating procedure can also include a measurement of the amount of time needed to perform each step. For example, the analysis can include a measurement of the amount of time per step per incident type.

Analysis module 116 can provide the analysis of the incidents and the analysis of the steps of the standard operating procedure associated with each respective incident to a user. The user can be, for example, a manager of the site and/or system 100.

Analysis module 116 can provide the analysis to the user by, for example, displaying the analysis on a user interface of a computing device of the user, as illustrated by block 118 of FIG. 1. For instance, the analysis can be displayed in a dashboard format and/or in HTML format. The user interface can be, for example, user interface 346 further described in connection with FIG. 3.

Additionally or alternatively, analysis module 116 can provide the analysis to the user by generating a report including the analysis, as illustrated by block 120, and sending (e.g., exporting) the report to the user. The report can be, for example, in PDF, CSV, TIFF, or PNG format, and can be sent to the user via email or SMS, for example. Further, in some embodiments, the report can be sent to the user based on (e.g., according to) a pre-configured schedule.

Analysis module 116 can determine, based on the analysis of the incidents and/or the analysis of the steps of the standard operating procedure associated with each respective incident, a number of corrective actions to improve the steps of the standard operating procedure and/or improve the performance of the operator in managing the incidents. The corrective actions can include, for example, removing a number of the steps from the standard operating procedure, such as, for instance, the steps that the analysis indicates are being skipped, since this can be an indication that those steps are not actually needed to successfully manage the incident, and thus are inefficient to include in the standard operating procedure. The corrective actions can also include adding a number of steps to the standard operating procedure, such as, for instance, steps that the analysis may indicate would improve the operator's efficiency in managing the incident.

The corrective actions can also include reassigning the management of one or more of the incidents to a different operator. For instance, if the analysis indicates that one operator has a heavier management load than another operator (e.g., one operator is managing a greater number of incidents and/or performing a greater number of standard operating procedure steps than another operator), one or more of that operator's incidents can be reassigned to the other operator in order to improve the operator's efficiency in managing the incidents.

The corrective actions can also include assigning a level of security, such as, for instance, safe, low risk, or high risk, to the site and/or a particular area of the site. For example, the level of security could be assigned based on the type of incident(s) occurring at the facility. As an additional example, a level of security may be assigned to a particular area of the site if the analysis indicates a large number of the incidents occurring at the site are occurring in that particular area.

The corrective actions can also include creating a number of sub-categories within a particular incident type. For example, the sub-categories could be created for an incident type if the analysis indicates that a large number of the incidents occurring at the site are of that type and/or that creating the sub-categories would improve the operator's efficiency in managing that type of incident.

In some embodiments, analysis module 116 can automatically (e.g., without input from the user or in response to a command from the user) implement and/or perform the corrective actions. That is, in such embodiments, analysis module 116 can dynamically implement and/or perform the corrective actions based on its analysis.

In some embodiments, analysis module 116 can provide (e.g., propose) the corrective actions to the user. For example, analysis module 116 can include the corrective actions in the display provided to the user at block 118 or the report generated and sent to the user at block 120. The user can then review the proposed corrective actions and determine whether they should be implemented and/or performed.

FIG. 2 illustrates an example of an incident analysis 230 performed in accordance with one or more embodiments of the present disclosure. Incident analysis 230 can be performed by, for example, analysis module 116 previously described in connection with FIG. 1, and can be provided to a user as previously described in connection with FIG. 1.

As shown in FIG. 2, incident analysis 230 can include a summary of an open incident trend at a site for a particular time period (e.g., the week of Nov. 15 to Nov. 22, 2015). This summary includes both a status comparison and a priority level comparison of the incidents for that week. For example, as illustrated in FIG. 2, the trend is shown in graphical form, with a continuous line representing the number of open incidents at the site throughout the week and vertical bars representing the number of raised incidents and the number of closed incidents at different times throughout the week (e.g., at four different times each day). Further, the bars representing the number of raised and closed incidents include a breakdown of those incidents by priority level (e.g., how many of those incidents are urgent, high, and low priority).

Further, incident analysis 230 illustrated in FIG. 2 can include a status comparison and a priority level comparison of the incidents at the site in terms of total numbers. For example, incident analysis 230 illustrated in FIG. 2 indicates that 63 total incidents have been raised at the site, 57 of those incidents have been closed, and 6 remain open. Further, as shown in FIG. 2, 10 of those incidents have an urgent priority level, 35 have a high priority level, and 18 have a low priority level. These comparisons are presented in both numerical and graphical (e.g., bar) form, as illustrated in FIG. 2.

Further, as shown in FIG. 2, incident analysis 230 can include an analysis of the incidents at the site by type. For instance, incident analysis 230 includes a listing of the top five types of incidents at the site, and the amount of times each type of incident has occurred. For example, incident analysis 230 illustrated in FIG. 2 indicates that most frequently occurring type of incident is public disturbance (38 incidents), followed by theft (12 incidents), medical emergency (4 incidents), severe weather (1 incident), and bomb threat (1 incident). This listing is presented in both numerical and graphical (e.g., bar) form, as illustrated in FIG. 2.

Further, as shown in FIG. 2, incident analysis 230 can include an analysis of different operators' performances (e.g., efficiency) in managing the incidents. For instance, incident analysis 230 includes a listing of the number of incidents closed by the different operators. For example, incident analysis 230 illustrated in FIG. 2 indicates that operator Tim Blake has closed 34 incidents, operator Mike Tan has closed 33 incidents, operator Ron Nash has closed 14 incidents, and operator Steve Lim has closed 12 incidents. This listing is presented in both numerical and graphical (e.g., bar) form, as illustrated in FIG. 2. Further, the bars representing the number of incidents closed by each respective operator include a breakdown of those incidents by priority level (e.g., how many incidents closed by each respective operator were urgent, high, and low priority).

As shown in FIG. 2, incident analysis 230 can also include a segregation of the incidents occurring at the site for a particular time period (e.g., the month of September 2014) by type and time. As illustrated in FIG. 2, each segregation is shown in graphical form, with vertical bars representing the number of times each type of incident (fire, security breach, etc.) occurred during the month in the incident type segregation, and vertical bars representing the number of incidents that occurred during each week of the month in the time segregation. Further, the bars include a breakdown of each respective incident type each respective week by status (e.g., how many incidents represented by each respective bar are open, in progress, and closed).

FIG. 3 illustrates an example of a computing device 340 for incident management analysis in accordance with one or more embodiments of the present disclosure. Computing device 340 can be, for example, a laptop computer, desktop computer, or mobile device (e.g., smart phone, tablet, PDA, etc.), among other types of computing devices. However, embodiments of the present disclosure are not limited to a particular type of computing device.

As shown in FIG. 3, computing device 340 can include a memory 344 and a processor 342. Memory 344 can be any type of storage medium that can be accessed by processor 342 to perform various examples of the present disclosure. For example, memory 344 can be a non-transitory computer readable medium having computer readable instructions (e.g., computer program instructions) stored thereon that are executable by processor 342 to perform incident management analysis in accordance with the present disclosure. That is, processor 342 can execute the executable instructions stored in memory 344 to perform incident management analysis in accordance with the present disclosure.

Memory 344 can be volatile or nonvolatile memory. Memory 344 can also be removable (e.g., portable) memory, or non-removable (e.g., internal) memory. For example, memory 344 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 344 is illustrated as being located in computing device 340, embodiments of the present disclosure are not so limited. For example, memory 344 can also be located internal to another computing resource (e.g., enabling computer readable instructions to be downloaded over the Internet or another wired or wireless connection).

As shown in FIG. 3, computing device 340 can include a user interface 346. A user (e.g., operator) of computing device 340, such as, for instance, an operator or manager of system 100 previously described in connection with FIG. 1, can interact with computing device 340 via user interface 346. For example, user interface 346 can provide (e.g., display and/or present) information to the user of computing device 340, such as, for instance, an analysis of a number of incidents at a site and an analysis of the steps of the standard operating procedure associated with each respective incident, as previously described herein. Further, user interface 346 can receive information from (e.g., input by) the user of computing device 346.

In some embodiments, user interface 346 can be a graphical user interface (GUI) that can include a display (e.g., a screen) that can provide and/or receive information to and/or from the user of computing device 340. The display can be, for instance, a touch-screen (e.g., the GUI can include touch-screen capabilities). As an additional example, user interface 346 can include a keyboard and/or mouse the user can use to input information into computing device 340. Embodiments of the present disclosure, however, are not limited to a particular type(s) of user interface.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for incident management analysis, comprising:
a memory; and
a processor configured to execute executable instructions stored in the memory to:
receive information associated with management of a number of incidents at a site, wherein each respective incident is managed by an operator using a standard operating procedure associated with that incident;
analyze the number of incidents using the received information; and
provide the analysis of the number of incidents to a user.

2. The computing device of claim 1, wherein:
the received information includes information associated with the operator's management of each respective incident; and
the analysis of the number of incidents includes an analysis of the operator's performance in managing the number of incidents.

3. The computing device of claim 1, wherein:
the received information includes information associated with steps of the standard operating procedure associated with each respective incident; and
the processor is configured to execute the instructions to:
analyze the steps of the standard operating procedure associated with each respective incident using the information associated with the steps of the standard operating procedure associated with each respective incident; and
provide, to the user, the analysis of the steps of the standard operating procedure associated with each respective incident.

4. The computing device of claim 1, wherein:
the computing device includes a user interface; and
the processor is configured to execute the instructions to provide the analysis of the number of incidents to the user by displaying the analysis of the number of incidents on the user interface.

5. The computing device of claim 1, wherein the analysis of the number of incidents includes:
a total amount of incidents that occurred during a particular time period;
an amount of the incidents that occurred during the particular time period that were resolved during the particular time period; and
an amount of the incidents that occurred during the particular time period that were not resolved during the particular time period.

6. The computing device of claim 1, wherein the analysis of the number of incidents includes:
a classification of the number of incidents into a number of different types; and
an indication of which type of incident has occurred most frequently.

7. The computing device of claim 1, wherein the analysis of the number of incidents includes:
a classification of the number of incidents into a number of different priority levels; and
an amount of incidents classified into each respective priority level.

8. The computing device of claim 1, wherein the processor is configured to execute the instructions to assign a level of security to the site based on the analysis of the number of incidents.

9. A method for incident management analysis, comprising:
receiving, by a computing device of an incident management system, information associated with steps of a standard operating procedure for management of an incident at a site;
analyzing, by the computing device, the steps of the standard operating procedure using the received information; and
providing, by the computing device, the analysis of the steps of the standard operating procedure to a user.

10. The method of claim 9, wherein the method includes determining, based on the analysis of the steps of the standard operating procedure, a number of corrective actions to improve the steps of the standard operating procedure.

11. The method of claim 10, wherein the method includes automatically implementing, by the computing device, the number of corrective actions in the steps of the standard operating procedure.

12. The method of claim 10, wherein the number of corrective actions include removing a number of steps from the steps of the standard operating procedure.

13. The method of claim 9, wherein providing the analysis of the steps of the standard operating procedure to the user includes:
generating a report including the analysis of the steps of the standard operating procedure; and
sending the report to the user.

14. The method of claim 9, wherein the analysis of the steps of the standard operating procedure includes an indication of the steps of the standard operating procedure being performed least frequently or not at all during management of the incident at the site.

15. A non-transitory computer readable medium having computer readable instructions stored thereon that are executable by a processor to:
receive information associated with an operator's management of a number of incidents at a site, wherein each respective incident is managed by the operator using a standard operating procedure associated with that incident;
analyze, using the received information, the operator's performance in managing the number of incidents; and
provide the analysis of the operator's performance to a user.

16. The computer readable medium of claim 15, wherein the instructions are executable to determine, based on the analysis of the operator's performance, a number of corrective actions to improve the operator's management of the number of incidents.

17. The computer readable medium of claim 16, wherein the instructions are executable to provide the number of corrective actions to the user.

18. The computer readable medium of claim 16, wherein the number of corrective actions include reassigning management of one or more of the number of incidents to a different operator.

19. The computer readable medium of claim 16, wherein the analysis of the operator's performance includes a total amount of time needed by the operator to resolve the number of incidents.

20. The computer readable medium of claim 15, wherein the analysis of the operator's performance includes:
an amount of incidents currently being managed by the operator; and
an amount of incidents that have been resolved by the operator.
